(19) United States
(12) Patent Application Publication
(10) Pub. No.: US 2008/0102166 A1
(43) Pub. Date: May 1, 2008

(54) Fiber-Containing Confectionary Chews

(75) Inventors: Wade N. Schmelzer, St. Louis Park, MN (US); Janice M. Johnson, Eden Prairie, MN (US)

Correspondence Address: FISH & RICHARDSON P.C., PO BOX 1022, MINNEAPOLIS, MN, 55440-1022, US

(73) Assignee: Cargill, Incorporated

(21) Appl. No.: 11/924,929

(22) Filed: Oct. 26, 2007

Related U.S. Application Data
(60) Provisional application No. 60/855,083, filed on Oct. 26, 2006.

(51) Int. Cl. A23L 1/30; A23C 23/00; A23L 1/302; A23L 1/22

(52) U.S. Cl. 426/72; 426/534; 426/536; 426/580; 426/648

(57) ABSTRACT

A confectionary chew is described that includes (a) a sweetener and (b) a fiber blend that includes at least 1% by weight short-chain inulin and at least 1% by weight a source of dietary fiber other than short-chain inulin. Processes for preparing confectionary chews including short chain inulin and another source of dietary fiber are also described.

### CLAIM OF PRIORITY

This application claims priority under 35 USC §119(e) to U.S. Patent Application Ser. No. 60/855,083, filed on Oct. 26, 2006, the entire contents of which are hereby incorporated by reference.

### TECHNICAL FIELD

This invention relates to confectionary chews, and more particularly to confectionary chews with added fiber.

### BACKGROUND

A confectionary chew is a pliable, primarily sweetener-based candy having a chewy texture. Confectionery chews are enjoyed and consumed by many people. These items remain popular for reasons such as their sweet taste, smooth texture, and pleasing mouthfeel. However, confectionery chews are typically regarded as unhealthy because sugar or other sweetener is usually a primary ingredient.

Health professionals generally agree that dietary fiber is important for good human health. However, most individuals do not meet the American Dietetic Association recommended intake of 20 to 35 grams of fiber a day. For example, most Americans' mean fiber intake is about half the average recommended level, at 14-15 grams a day. Dietary fiber is available from ‘roughage’ like fruits, vegetables, whole grains, nuts/seeds, and beans. However, these foods are not a large part of many current dietary eating habits, resulting in individuals ingesting less than the recommended intake of dietary fiber.

The FDA has approved food labels for fiber-containing products to aid consumers. According to the FDA, a food product label or package can state that a product is “a good source” of fiber if it contributes 10 percent of the Daily Value (“DV”), or 2.5 grams of fiber per serving. The product label or package can claim “high in,” “rich in,” or “excellent source of” fiber if the product provides 20 percent of the DV, or 5 grams per serving.

### SUMMARY

A confectionary chew is described that includes (a) a sweetener, and (b) a fiber blend comprising at least 1% by weight short-chain inulin and at least 1% by weight of a source of dietary fiber other than short-chain inulin. As used herein, “short chain inulin” is an inulin characterized by a low degree of polymerization (“DP”), with at least 70% of the material having a chain length of 10 DP or less.

The confectionary chew may have at least 2.5 grams of dietary fiber per 12 gram serving, or may have at least 5 grams of dietary fiber per 12 gram serving. The fiber blend may also include at least 5% by weight short-chain inulin, and at least 5% by weight of a source of dietary fiber other than short-chain inulin, or at least 10% by weight short-chain inulin, and at least 10% by weight of a source of dietary fiber other than short-chain inulin. The source of fiber other than short-chain inulin may include inulin other than short-chain inulin. The confectionary chew may also include other components, including flavoring, one or more vitamins and minerals, calcium, a dairy-based product, or glycerine. The sweetener may include high fructose corn syrup, corn syrup, sucrose, fructose, or combinations thereof. In some embodiments, the use of a fiber blend can reduce the amount of sweetener and/or corn syrup used in the confectionary chew relative to chews lacking the fiber blend.

A process for producing a confectionary chew is described that includes cooking the mixture comprising the sweetener and fiber blend to a sufficient temperature to produce a cooked mixture that will form a chew when cooled to room temperature (e.g. to a temperature of at least 212° F.), cooling the cooked mixture, and forming confectionary chews from the cooked mixture.

The details of one or more embodiments of the invention are set forth in the description below.

### DETAILED DESCRIPTION

Confectionery chews are described that include (a) a sweetener and (b) a fiber blend of short-chain inulin and at least one other fiber. The chews having added fiber may retain the original sensory attributes, or nearly the same sensory attributes, as a comparable confectionary chew lacking fiber. Attributes of chews that may be preserved include soft texture and good eating quality. A confectionery chew with added fiber may be used as a consumer food product, or may be used as a supplement-type product.

One component used in producing a confectionary chew is a sweetener. Examples of sweeteners that can be used in the chews include sucrose, fructose, corn syrup, and high fructose corn syrup. Some chews may be produced using multiple sweeteners, sweeteners in multiple types (such as granulated sugar and powdered sugar), or in other combinations.

Another component used in producing a confectionary chew is a fiber blend. A fiber blend includes a combination of fiber sources, and is used to provide fiber for the chew. In some embodiments, the use of a fiber blend can yield a confectionery mass with manageable viscosity during cooking and with good texture (chew) properties upon cooling. The fiber blend may be prepared by combining a mixture of fibers prior to addition of the blend to a composition. The fiber blend may also be produced by adding two or more fibers separately to a composition. Fiber blends include a combination of short-chain inulin with at least one other fiber source. As defined above, short-chain inulin is characterized by a low degree of polymerization, with at least 70% of the material having a chain length of 10 DP or less. In some embodiments, nearly all the material in a short chain inulin may have a chain length of 20 DP or less. Furthermore, in some embodiments, a short-chain inulin may be used with at least 90% of the material of the short chain inulin having a chain length of 10 DP or less. An example of a suitable commercially available source of short chain inulin is Oliggo-Fiber® F97 (available from Cargill, Minnetonka, Minn.). Various methods may be used for the analysis of inulin DP. These methods include quantitative analysis using high performance anion exchange chromatography. Another method for analysis of inulin DP is described in J. W. Timmermans et al., Quantitative analysis of the molecular weight distribution of inulin by means of anion exchange HPLC with pulsed amperometric detection, Journal of Carbohydrate Chemistry, vol. 13, no. 6, pp. 881-888 (1994).

Examples of suitable fiber sources for combination with short-chain inulin include insoluble, soluble, and viscous fibers. Specific examples include native inulin, modified inulin, instant inulin, psyllium, beta-glucan, arabano-galactan, guar, and modified guar.

The total amount of fiber blend present in the confectionary chew can vary. For example, a sufficient amount of fiber blend may be present in the chew to produce a confectionery chew that is a “good” source of dietary fiber (FDA labeling standard). In this case, the fiber blend will be present in a final amount of 20.8% by weight or greater (to achieve 2.5 grams fiber per 12 gram serving). In another example, the amount of fiber blend may be selected to produce a confectionery chew that is an “excellent” source of dietary fiber (FDA labeling standard). In this case, the fiber blend will be present in a final amount of 41.6% by weight or greater (to achieve 5.0 grams fiber per 12 gram serving). In some embodiments, confectionery chews can be produced that have even greater levels of fiber blend. For example, a chew may be produced having 45% by weight, 50% by weight, or more fiber blend present in the fiber chew. In some embodiments (e.g., to maintain good texture and sensory qualities), the amount of fiber blend present in the chew may be 75% by weight or less (e.g. 65% by weight or less).

The fiber blend may include at least 1% by weight short-chain inulin and at least 1% by weight of at least one other (non short-chain inulin) fiber source. In various embodiments, the fiber blend may include at least 5% by weight, at least 10% by weight, at least 15% by weight, at least 20% by weight, at least 25% by weight, at least 33% by weight, or at least 50% by weight or more short-chain inulin. In various embodiments, the fiber blend may include at least 5% by weight, at least 10% by weight, at least 15% by weight, at least 20% by weight, at least 25% by weight, at least 33% by weight, or at least 50% by weight or more other fiber sources.

The fiber blend used may include various ratios of short-chain inulin with the other fiber source(s). In one embodiment, the ratio of short-chain inulin to other fiber source(s) may range from 0.5:1 to 4:1. Other examples of suitable ratios include from 1:1 to 3:1 short-chain inulin to other fiber source(s), or from 1.5:1 to 2:1 short-chain inulin to other fiber source(s).

The fiber blend may be formed by mixing fiber sources together prior to mixing the blend with other components in a confectionary chew. The fiber blend may also be formed by adding fibers separately to a confectionary chew mixture such that the fiber blend is formed or produced as part of the process of preparing the confectionary chew.

Optionally, additional components may also be used in producing a confectionary chew. Examples of other components that may be used include water, corn syrup, vegetable oil, lecithin, dairy based products (such as sweetened condensed milk, milk, cream, and dry milk), and other liquids and solids. In some embodiments, additional components may be added to alter various qualities of the resulting chews. For example, glycerine may be added to reduce the tackiness of the chews.

Other additional components that may be used in a confectionary chew include flavorings and colorants. In various embodiments, flavorings and colorants may be used to increase appeal or provide variety in the confectionery chews. For example, a chocolate chew may be produced using chocolate, chocolate powder, cocoa powder, or other chocolate flavorings and syrups. As another example, fruit or citrus chews may be produced using a variety of natural and artificial flavors and colorings.

Other additional components that may be used in a confectionary chew include vitamins, minerals, other health additives, and supplements. In various embodiments, iron, calcium, vitamin C, vitamin B12, etc. could be added to the confectionery chews to improve the health aspects of the chews, the provided health benefits, or to provide additional nutrition options. For example, calcium may be added to a chew containing inulin fiber, as inulin may improve calcium uptake in the body.

The chews can be produced by cooking a combination of ingredients including sweetener, fiber blend, and other components and additives, and then cooling the resulting cooked mixture. The temperature target for cooking can vary based on the components used. The mixture may be cooked to a sufficient temperature to produce a cooked mixture that will form a chew when cooled to room temperature. Typically, this will include cooking to a temperature sufficient to drive off water from the mixture (e.g., to a target temperature of 212° F. or higher).

The components may be combined in various manners. The combination of components may be influenced by the amounts and types of components used. In one embodiment, all the components may be added sequentially to form a composition used to produce a chew. In other embodiments, the ingredients may be added in various combinations, or simultaneously to produce a composition. The combination of components may also vary relative to the cooking process. In some embodiments, all of the components are combined together before cooking. In other embodiments, some of the components are added together, the composition cooked, and then the remaining components added to produce a chew. In other embodiments, the components can be added in various combinations and in various sequences before, during, and after cooking.

### EXAMPLES

### Example 1

### Chocolate Chew

A chocolate confectionery chew was prepared using the ingredients described in Table 1, according to the following procedure:
1. The partially hydrogenated vegetable oil, lecithin, canola oil, baking chocolate, and cocoa powder were combined in a pan and stirred over medium-high heat on a gas stovetop until homogeneous.
2. The high fructose corn syrup, glycerine, and water were then added to the pan on the stovetop with continued stirring until all ingredients were well mixed.
3. The granulated sugar, fiber blend (F97 and Instant Inulins), and nonfat dry milk were then added to the mixture in the pan while stirring.
4. The mixture was continuously stirred while heating until the solids were dissolved resulting in a homogeneous mass, which occurred near a target temperature of 230° F. (approx. 15 minutes)
5. The mixture was transferred to a Hobart mixing bowl and mixed using a paddle type attachment for 5 minutes on setting 6.
6. The powdered sugar was added and mixed at the same setting for an additional 5 minutes.
7. The mixture was then poured onto a marble slab, and placed into a refrigerator to cool for 15 minutes.

8. The pieces were then cut into desired sizes and weights (approx. 6 gram pieces), and wrapped in wax lined candy wrapping paper.

TABLE 1
Chocolate Chew Ingredients

| Ingredient | Wt. (g) | % wt. | Moisture % | SNF, % |
|---|---|---|---|---|
| Sugar, granulated | 200 | 20.00% | | 20.00% |
| Sugar, powdered | 20 | 2.00% | | 2.00% |
| High fructose corn syrup | 35 | 3.50% | 0.81% | 2.70% |
| (HFCS42) | | | | |
| Glycerine, pre-treated | 20 | 2.00% | | |
| (Golden Select #2001) | | | | |
| Inulin, F97 | 295 | 29.50% | | 29.50% |
| Inulin, Instant | 165 | 16.50% | | 16.50% |
| High Oleic Canola Oil | 13 | 1.30% | | |
| (Clear Valley 65) | | | | |
| Partially hydrogenated | 25 | 2.50% | | |
| vegetable oil (Crisco) | | | | |
| Lecithin (Leciprime 1500) | 2 | 0.20% | | |
| Nonfat Dry Milk | 25 | 2.50% | | 2.50% |
| Water | 170 | 17.00% | 17.00% | |
| Baking Chocolate | 15 | 1.50% | | |
| Cocoa Powder | 15 | 1.50% | | 1.50% |
| (10/12 Russet Plus) | +UZ,13/32 | | | |
| | 1000 | 100.00% | 17.81% | 74.70% |

The cooked weight of the mixture was 895 grams. Therefore, there was a moisture loss of approximately 8.67% during cooking [(1−895/980)×100]. The typical fiber composition of the inulin products are 88%(w/w) for OliggoFiber® Instant inulin and 93%(w/w) for OliggoFiber® F97. Based on these purities, the amount of fiber in the final cooled mass was about 45.9% [((295*0.93)+(165*0.88)/915)*100]. Therefore, a 12 gram serving of the confectionery chew had a fiber content of 5.50 grams, which exceeded the “excellent” source of fiber standard of 5 g per serving (based on the FDA standard of “excellent” described earlier).

The confectionery mass was initially somewhat soft and sticky following cooling, causing slight issues with effective release from the marble slab. However, after equilibrating overnight, the chew was evaluated and found to have good flavor and a desirable texture. Samples were wrapped in plastic wrap and stored in a cool, dry location. After 6 months of storage, the chews maintained a good texture and overall quality.

### Example 2

### Raspberry Chews

Confectionery chews 2A and 2B were prepared using the ingredients described in Table 1, according to the following procedure:
1. The granulated sugar and inulin F97 were blended together and set aside.
2. The partially hydrogenated vegetable oil, lecithin, and corn syrup(s) were combined together in a pan and stirred over medium-high heat on a gas stovetop until homogeneous.
3. The water was added to the pan and mixed.
4. The granulated sugar and inulin blend (from step 1) was added to the pan and mixed with a hand mixer until well-blended.
5. The mixture was then heated with stirring until reaching a target temperature of 245° F.
6. The cooked mixture was transferred to a tared mixing bowl and weighed.
7. The citric acid was added to the mixture and mixing continued for 2 minutes in the mixing bowl.
8. The sweetened condensed milk was added and the mixture mixed for an additional 5 minutes.
9. The flavor was added and the mixture mixed for an additional 2 minutes.
10. The powdered sugar was added and the mixture mixed for about 5 minutes, then the barley beta-glucan was added, and the mixture mixed until it became difficult to mix (an additional 5-10 minutes).
11. The mixture was then poured onto a marble slab, and placed into a refrigerator to cool for 15 minutes.

12. The pieces were then cut into desired sizes and weights (approx. 6 gram pieces), and wrapped in wax lined candy wrapping paper.

TABLE 2
Raspberry Chew Ingredients

| | Chew 2A | | Chew 2B | |
|---|---|---|---|---|
| Ingredient | Wt. (g) | % wt. | Wt. (g) | % wt. |
| Sugar, granulated | 412 | 32.06% | 412 | 31.77% |
| High fructose corn | | | 246 | 18.97% |
| syrup (HFCS43) | | | | |
| High fructose corn | 370 | 28.79% | 133.7 | 10.31% |
| syrup (HFCS63) | | | | |
| Partially hydrogenated | 73.6 | 5.73% | 73.6 | 5.68% |
| vegetable oil (Crisco) | | | | |
| Lecithin (Leciprime 1500) | 2 | 0.16% | 2 | 0.15% |
| Inulin, F97 | 145 | 11.28% | 145 | 11.18% |
| Water | 65 | 5.06% | 65 | 5.01% |
| Pre-cook mix | 1067.6 | | 1077.3 | |
| Barley Beta-Glucan | 87.7 | 6.82% | 89.5 | 6.90% |
| Sugar, powdered | 20 | 1.56% | 20 | 1.54% |
| Sweetened Condensed Milk | 104.5 | 8.13% | 104.5 | 8.06% |
| Citric Acid | 3.4 | 0.26% | | 0.26% |
| Raspberry Flavoring | 2 | 0.16% | 2 | 0.15% |
| (Firmenich 598777T) | +UZ,14/32 | | | |
| Total | 1285.2 | 100.00% | 1296.7 | 100.00% |

The cooked weight of Chew 2A was 996.6 grams, thus producing a chew having a fiber content of [(145+87.7)/(996.6+87.7)]=21.5 wt. %, or 2.58 g fiber per 12 gram serving. The cooked weight of chew 2B was 1017.0 grams, thus producing a chew having a fiber content of [(145+87.7)/(1017+89.5)]=21.0 wt. %, or 2.52 g fiber per 12 gram serving. Therefore both chews 2A and 2B exceed the FDA standard of a “good” source of fiber.

The confectionary masses were initially firm after cooling. Chew 2A was initially chewier in texture than chew 2B. After fully cooling the chews, they became somewhat hard and breakable, but chewing them remained very easy. Chew 2A remained chewier than chew 2B.

After three days of storage in the dark at room temperature, the chews became very hard and difficult to cut. However, they still chewed nicely, with chew 2A still chewier than chew 2B.

After 11 days of storage in the dark at room temperature, the chews were quite hard. Chew 2A however, still chewed nicely and had a good chewy texture. Chew 2B was quite firm when chewing.

A number of embodiments of the invention have been described. Nevertheless, it will be understood that various modifications may be made without departing from the spirit and scope of the invention. Accordingly, other embodiments are within the scope of the following claims.

What is claimed is:

1. A confectionary chew, comprising:
(a) a sweetener; and
(b) a fiber blend comprising at least 1% by weight short-chain inulin and at least 1% by weight of a source of dietary fiber other than short-chain inulin.

2. The confectionary chew of claim 1, wherein the confectionery chew has at least 2.5 grams of dietary fiber per 12 gram serving.

3. The confectionary chew of claim 1, wherein the confectionery chew has at least 5 grams of dietary fiber per 12 gram serving.

4. The confectionary chew of claim 1, wherein the fiber blend comprises at least 5% by weight short-chain inulin, and at least 5% by weight of a source of dietary fiber other than short-chain inulin.

5. The confectionary chew of claim 1, wherein the fiber blend comprises at least 10% by weight short-chain inulin, and at least 10% by weight of a source of dietary fiber other than short-chain inulin.

6. The confectionary chew of claim 1, wherein the source of dietary fiber other than short-chain inulin comprises inulin other than short-chain inulin.

7. The confectionary chew of claim 1, further comprising one or more vitamins and minerals.

8. The confectionary chew of claim 1, further comprising calcium.

9. The confectionary chew of claim 1, further comprising a dairy-based product.

10. The confectionary chew of claim 1, further comprising glycerine.

11. The confectionary chew of claim 1, wherein the sweetener comprises high fructose corn syrup, corn syrup, sucrose, fructose, or combinations thereof.

12. The confectionary chew of claim 1, wherein at least 90% of the short-chain inulin has a chain length less than 10 DP.

13. A process for producing a confectionary chew, comprising:
cooking a mixture that includes a sweetener;
cooling the cooked mixture; and
forming confectionary chews from the cooked mixture, wherein the confectionary chews comprise a fiber blend including at least 1% by weight short-chain inulin and at least 1% by weight of a source of dietary fiber other than short-chain inulin;

14. The process of claim 13, wherein the mixture is cooked to reach a temperature of at least 212° F.

15. The process of claim 13, wherein the mixture further comprises a dairy-based product.

16. The process of claim 13, wherein the mixture further comprises glycerine.

17. The process of claim 13, wherein the mixture further comprises one or more vitamins and minerals.

18. The process of claim 13, wherein the mixture further comprises calcium.

19. The process of claim 13, wherein part of the fiber blend is added to the mixture before cooking, and part of the fiber blend is added to the cooked mixture.

20. The process of claim 13, wherein all of the fiber blend is added to the mixture before cooking.
